(19) United States
(12) Patent Application Publication
(10) Pub. No.: US 2004/0255884 A1
(43) Pub. Date: Dec. 23, 2004

(54) Internal combustion engine with harmonic synchroniser

(76) Inventor: Phillip John Arnold, Tasmania (AU)

Correspondence Address: Edwin D Schindler, Five Hirsch Avenue, P O Box 966, Coram, NY, 11727-0966, US

(21) Appl. No.: 10/494,066

(22) PCT Filed: Oct. 29, 2002
(86) PCT No.: PCT/AU02/01471

(30) Foreign Application Priority Data
Oct. 29, 2001 (AU) PR 8534

(51) Int. Cl. F02B 33/04

(52) U.S. Cl. 123/73 R

(57) ABSTRACT

An internal combustion engine in which the combustion mixture passing into the cylinder (4) includes a pressure pulse formed during the preceding closure of the inlet (6) so that the volume of combustion mixture passing into the combustion chamber is greater than would normally be delivered. In a particular form during the charging of the engine, part of the combustion mixtures passes through the combustion chamber to exhaust (5) and is forced back into the combustion chamber by means of a pressure pulse in the exhaust system which pulse is formed from previous combustion, thereby effectively super charging the chamber before the inlet and exhaust ports are closed and the compression effected. This is particularly suitable for two stroke engines but the invention can be applied to other engines such as four strokes and ram or scram jet engines.

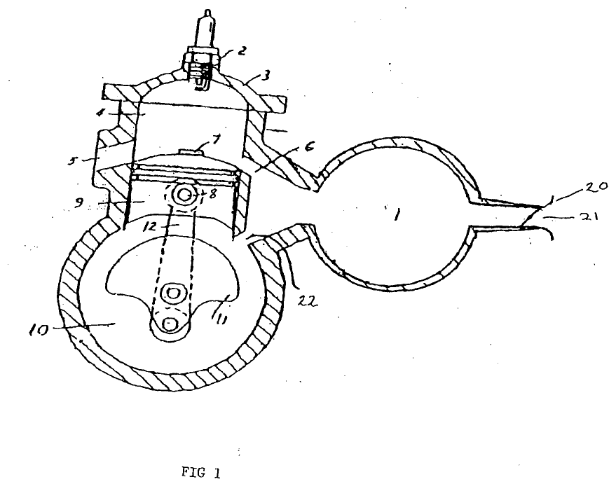

This invention relates to a harmonic synchronizer system and in particular to a system which is adapted to be used with internal combustion piston engines but which can also be used in respect of various types of jet engines.

For ease of description we shall describe the invention as applied to a two stroke spark ignition engine but, again, it is to be understood that it would equally well be applicable to other engines as will be described later.

Two stroke internal combustion engines are, of course, generally well known and a characteristic of such engines is that the induction is effected by initially having the combustion mixture fed into the sump of the engine and there being an interconnection between the sump and the cylinder which is so arranged that, as the piston effects its power stroke, the movement of the piston reduces the volume therebeneath and pressurises the sump so that when the exhaust and inlet ports are opened there is pressure by the combustion mixture entering into the cylinder which adds to the general pressure inside the cylinder to ensure rapid scavenging of the exhaust gases from the cylinder and the replacement by the combustion mixture, both actions being completed before the piston moves sufficiently upwardly to close the inlet port.

Two stroke engines are normally provided with an inlet valve which may be piston ported, a rotary valve, a reed valve or some other form of valve which can act to control the inlet of the combustion mixture into the crank case.

For convenience, in this specification, the term combustion mixture will not only take its normal meaning, a mixture of air and a combustible atomised fuel but can also comprehend air only where there is to be direct injection into the combustion chamber of the fuel.

The object of the invention is to provide an internal combustion engine with means whereby more effective operation of the engine and effective super charging of the engine can be provided during operation thereof.

The invention, in its broadest sense, includes an internal combustion engine in which the combustion mixture passing into the cylinder includes a pressure pulse so that the volume of combustion mixture passing into the combustion chamber is greater than would normally be delivered.

In one form of the invention I provide an internal combustion engine where in during charging of the engine, part of the combustion mixture passes through the combustion chamber to exhaust and is then forced back into the combustion chamber by means of a pressure pulse in the exhaust system, thereby effectively super charging the chamber before the inlet and exhaust ports are closed and the compression and combustion is effected.

In the case of a two stroke engine we provide an accumulator which can also act as an harmonic synchroniser or air spring which can be the sump of the engine so that, as the piston moves down on its power stroke, there is a compression of the combustion mixture in the accumulator and when it is possible for the combustion mixture to enter the combustion chamber this acts to scavenge the exhaust gases and part of this to pass through the exhaust port which portion is acted upon by an exhaust pulse which inverts the flow driving it back into the cylinder so that when the ports close the combustion mixture in the cylinder is substantially greater than would normally be achieved by natural aspiration.

The physical arrangement of the accumulator is such that when the inlet closes, there is a pulse formed in the accumulator which pulse returns to the inlet as it is opening for the next stroke and this pressure pulse assists in rapid filling of the combustion chamber and the movement of part of the combustion mixture through the combustion chamber to the exhaust.

In the case of a four stroke engine, the accumulator is provided in the inlet system so that during the induction stroke the flow of combustion mixture into the cylinder comes from a volume of combustion mixture substantially greater than that required to fill the cylinder and the movement of the mixture into the cylinder sets up a flow pattern which effectively causes more combustion mixture to enter the cylinder than would normally be the case.

This flow pattern comprises a pressure wave (and its harmonics) which is set up when the inlet valve closes, the dimensions of the accumulator being such that the wave or a harmonic returns to the inlet port as the valve opens for the next stroke thereby permitting combustion mixture under pressure to be passed to the combustion chamber.

In order that the invention may be more readily understood I shall describe one particular form of the invention when applied to a two stroke engine with some comments relating to the application of the invention in other applications.

In general terms, the engine may be of relatively conventional form having a cylinder in which there is mounted a piston having piston rings to make a seal with the side walls of the cylinder, a spark plug mounted, normally in the head of the cylinder.

There can be an inlet for the combustion mixture, and this term is used for convenience and includes either a mixture of fuel or air or air only where direct injection of fuels is used. This inlet may pass to the sump or otherwise, as described later.

There can be a transfer means from the sump to the cylinder, which may be a valve in the head of the piston but could be a port from the sump to the cylinder. There is also an exhaust port in the cylinder wall which is only exposed when the piston is near the bottom of its movement.

In this specification, where terms of orientation are used it is to be understood that these are used for convenience, if the cylinder is downwardly directed or if the cylinder is horizontal, the correct orientation can be considered.

To this extent the engine can be considered conventional.

Also, there is a crank shaft to which a connecting rod from the piston may connect and there may be some form of balancer to take into account the movement of the piston, the balancer in the case of a single cylinder engine normally being a counter weight which provides a balance with the reciprocating movement of the piston.

The exhaust port can be more or less conventional and the inlet and exhaust ports are preferably both located adjacent the lower end of the movement of the piston so the piston has effectively completed its power stroke before exhaust is permitted to pass from the cylinder and the combustion mixture passed therein.

The sump, or space generally beneath the piston, can act as the accumulator and it is normally of a larger size than the sump of a conventional two-stroke engine and is adapted to receive a volume of combustion mixture which may be substantially greater than the volume required to fill the combustion chamber.

The engine can also be arranged so that, at the inlet side, there can be an external port to which a carburetor or other fuel metering device can be connected and which may be branched, one branch being an inlet port which enters into the sump and the other is a boost port which passes directly to the cylinder.

In operation, after the piston is close to the bottom of its movement after firing, the exhaust port opens and because there is a relatively low pressure of the exhaust side and a relatively high pressure in the cylinder, inlet side the exhaust gas is caused to move through the exhaust port to the exhaust system.

The combustion mixture can pass from the sump and if provided further combustion mixture can pass directly through the boost port to the cylinder. The movement of the combustion mixture may be such as to assist scavenging of the exhaust gases and complete or almost complete removal of the exhaust gasses from the cylinder.

The arrangement of the invention is such that more than a full charge of combustion mixture can enter the cylinder during this time and some of this follows the exhaust gas through the exhaust port.

This arrangement can be assisted by the correct design of the sump. As inlet ceases relatively rapidly, there is a pressure pulse set up by the closure of the inlet and this reflects back through the sump until it strikes a wall of the sump when it is caused to return and provided the pulse or a harmonic of this reaches the inlet as it opens, the pressure of the inlet combustion mixture is greater than the static pressure and thus the volume of combustion mixture which passes into the combustion chamber is enhanced.

The drawing illustrates this construction and there is a cylinder 4 having a piston 9 with a connecting rod 12 connecting the piston to a crank shaft 11, shown as having a balance weight. A spark plug 2 is located in the cylinder head.

The inlet 20 may have a butterfly or the like 21 which enables flow control of the combustion mixture which, in this case, would be a mixture of petrol and air.

The inlet passes into a synchroniser chamber 1 which has an outlet which permits the combustion mixture to pass to the sump 10 by way of passage 22 and also has a transfer port 6 as will be described later.

The sump 10 is of a substantial size relative to the swept volume in the cylinder.

The piston 9 has a transfer port 7 located in the upper surface thereof.

The cylinder also has an exhaust port 5 passing through the wall thereof.

The operation of this engine is effectively as described above.

When the engine is operating and the piston 9 passes above the boost port 6 and the exhaust port 5, the combustion mixture is compressed in the cylinder and at or close to top dead centre the spark plug 2, fires the combustion mixture ignites and expands in volume providing a downward force on the piston and ultimately rotation of the crank shaft.

Once the piston passes the exhaust port there is an immediate flow of exhaust gas through the port 5 and this helps the induction of the combustion mixture part of which passes through the transfer port 7 and part directly through the boost port 6 and the mixture passes into the cylinder.

Also as the combustion mixture in the sump has a pressure pulse due to the rapid closing of the inlet during the last stroke and because of the physical formation of the sump the pulse or a harmonic thereof reaches the inlet as it opens, the volume of combustion mixture which passes into the combustion chamber is enhanced.

Because of the general arrangement, this tends to be a rapid passage and, whilst the piston is moving through the lower portion of its movement, the quantity of combustion mixture which enters the cylinder is in fact greater than the volume of the cylinder and the certain percentage of thus passes out through the exhaust port 5.

The exhaust system is arranged so that there is a pulse in the system and the timing of this pulse is such that, just before the exhaust port is closed, the pulse is received back at the port and this causes the combustion mixture, which has passed into the exhaust system, to be forced back into the cylinder, the exhaust port 5 and the boost port 6 are both closed and the combustion mixture in the cylinder is already under a degree of pressure as there is more combustion mixture than would be the case with natural aspiration.

The combustion mixture is then further compressed by the movement of the piston and, ultimately, fires.

Whilst in this particular embodiment we show both an external chamber 1 and an enlarged sump 10 it is to be understood that the engine can be developed with either of these or both of them, as required in particular applications.

The exhaust gas, as it passes through the exhaust port into the exhaust system, can be considered to be a pulse with the pressure dropping as the exhaust leaves the port and passes into the system and the exhaust system can be designed so that there is reflection of this pulse in the exhaust system and the exhaust gas tends to move rearwardly or move upstream towards the exhaust port before finally venting.

In fact there may be a number of reflections of the exhaust but it will be appreciated that the next stroke will provide further exhaust so that, overall, there is an outward flow of the combustion gases but with pulses passing back to the exhaust port and, when the exhaust is properly tuned, the reflection of these pulses is in time with the operation of the engine.

The design of the exhaust system is such that the pressure pulse returns to adjacent the exhaust port just prior to the closing of the port so the return of the combustion mixture to the combustion chamber is optimised.

This combines effect of the normal movement of the combustion mixture through the transfer port, the combustion mixture from the boost port and the combustion mixture which returns from the exhaust system means that the amount of combustion mixture in the cylinder can be substantially greater than the amount that would normally be induced into the cylinder in a two stroke engine and thus the engine can be considered to be super charged but without the necessity of providing a mechanical or a turbo type super charger.

The arrangement is such that as the mass of combustion mixture reaches its maximum both the exhaust port and the inlet ports are closed and compression and ignition is effected. Using the engine of the invention, the inlet valve may be maintained open for a period longer than usual.

At the same time, the inlet charge which had been passing through the boost port of the inlet system is diverted by way of the second passage to enter the accumulator.

The accumulator is designed to be of such a capacity as to absorb the total amount of combustion mixture which passes into the volume between power cycles.

It is appreciated that, during the induction stroke, there is a momentum built up in the combustion mixture and this momentum continues after the closure of the inlet port and the mass of combustion mixture in the accumulator can continue to increase during the compression stroke of the piston thus building up a degree of pressure in the accumulator.

Once the power stroke is effected and the inlet ports open this mass has built up substantially and the cycle recommences.

I have found that one can get an increase in power from an engine of this type between 10% and 100% depending on the correct parameters being selected particularly in the exhaust system where the outgoing exhaust draws a substantial quantity of the combustion mixture through the combustion chamber and the pressure pulse returning to the exhaust port ensures that a major part of this is returned to the combustion chamber under the pressure of the pulse.

These parameters also include the size and volume of the accumulator and the mass of the combustion mixture.

It will be appreciated from the foregoing description that the fuel/air mixture from the metering device can flow at all times during the operation of the engine so there is no necessity of providing any form of inlet valve. A valve may be required to assist in starting the engine but once it is operating, this valve is no longer used.

The accumulator acts to permit the exhaust and inlet pulses to operate independently but synchronises them when the inlet and exhaust systems are both open.

The invention minimises the problems normally associated with engines of this type which are known to “come on the pipe” or “hit the power band” when the various parameters are all correct but these parameters may only be correct during a relatively narrow part of the operating range making such engines “peaky”.

The system of the invention can be applied to four stroke engines on the inlet side where the available combustion mixture is greater than the quantity required to fill the combustion chamber and it may be desirable that the exhaust system, possible at the exhaust manifold would include an expansion chamber into which part of the charge can pass and from which it is caused to move back into the cylinder on receiving an exhaust pulse. Such an arrangement has never been used on a four stroke engine. I may add an anti-reversion cone fitted on the downstream side of the cylinder to eliminate every second pulse. Alternatively, as the inlet and exhaust vales are only both open at the end of the exhaust stroke and the beginning of the inlet stroke, the return of combustion mixture can only occur when this occurs.

These, of course, take into account the fact that such engines only fire on every second cycle of the piston, not every cycle as in the case with two stroke engines.

In this case, the maximum benefit may be achieved from the inlet side. In this case there is an accumulator on the inlet side the dimension of which are adopted so that the pulse which is formed at the closure of the inlet valve is propagated in the accumulator and the pulse, or a harmonic of this returns to the inlet valve as it opens. It may be that as the inlet on a four stroke engine only opens on every second revolution the pulse has passed from side to side of the accumulator more than once before the inlet valve next opens, the critical matter is that the pulse reaches the inlet valve whilst it is open and, preferably as it opens.

The invention can also be applied to ramjet and scramjet jet engines between the inlet and exhaust sections of the jet and could be made to provide variable operating parameters so there can be continuous operation of the jet from sub-sonic through super-sonic to hyper-sonic speeds.

It will be appreciated that in this specification I have described one particular preferment of the invention but it is to be understood that various modifications can be made in this, as well as the application of the invention to other applications, and these remain within the spirit and scope of the invention.

1-15. (canceled).

16. An internal combustion engine, comprising:
a pressure pulse for regulating volume of a combustion mixture; and,
a cylinder having a combustion chamber into which the combustion mixture is able to pass, said pressure pulse regulating the volume of the combustion mixture passing into said combustion chamber so that the volume of the combustion mixture would be greater with said pressure pulse than the volume of the combustion mixture passing into said combustion chamber would be without said pressure pulse.

17. The internal combustion engine according to claim 16, wherein said cylinder includes an inlet with said pressure formed by a rapid closure of said inlet on a preceding stroke of said internal combustion engine, with dimensions of the volume in which the combustion mixture is held allowing for said pressure pulse to return to said inlet as said inlet reopens.

18. The internal combustion engine according to claim 16, further comprising, during charging of said internal combustion engine, means for a portion of the combustion mixture passing through said combustion chamber to exhaust and be forced back into said combustion chamber via an additional pressure pulse formed from a prior combustion, thereby super-charging said combustion chamber before said inlet and exhaust ports are closed and compression and combustion is effected.

19. The internal combustion engine according to claim 16, further comprising an exhaust system having an exhaust port, said exhaust system inducing at least one said pressure pulse, which returns at least to adjacent said exhaust port prior to a closing of said exhaust port, for causing the combustion mixture, after having passed through said combustion chamber, into said exhaust system to be forced by said pressure pulse into said combustion chamber.

20. The internal combustion engine according to claim 16, wherein said cylinder has inlets capable of opening and closing, so that when said inlets are open, initial movement of an exhaust gas from said combustion chamber induces the combustion mixture into, and through, said combustion chamber prior to a return of said pressure pulse.

21. The internal combustion engine according to claim 16, wherein said combustion mixture passes into a volume greater than a volume of said combustion chamber before passing thereto.

22. The internal combustion engine according to claim 21, wherein said internal combustion engine is a two-stroke engine and the combustion mixture passes to a sump prior to being fed to said combustion chamber, wherein said sump has a volume greater than that required for filling said combustion chamber, so that when the combustion mixture passes to said combustion chamber, there is substantially no limitation on the combustion mixture available for passes into said combustion chamber and therebeyond.

23. The internal combustion engine according to claim 22, wherein said cylinder has an inlet and said sump is arranged so that when said inlet closes, there is a pulse formed in said sump which said pulse returns to said inlet as said inlet is opening for a subsequent stroke of said two-stroke engine, with this said pulse assisting in a rapid filling of said combustion chamber and movement of a portion of the combustion mixture through said combustion chamber to an exhaust.

24. The internal combustion engine according to claim 21, wherein said internal combustion engine is a two-stroke engine having an accumulator with a volume greater than that required for filling said combustion chamber, so that when the combustion mixture passes to said accumulator, there is substantially no limitation on the combustion mixture available for passing into said combustion chamber and therebeyond.

25. The internal combustion according to claim 24, wherein said cylinder has an inlet and said accumulator is arranged so that when said inlet closes, there is a pulse formed in said accumulator, said pulse returning to said inlet as said inlet is opening for a subsequent stroke of said two-stroke engine, said pulse assisting in a rapid filling of said combustion chamber and movement of a portion of the combustion mixture through said combustion chamber to an exhaust.

26. The internal combustion engine according to claim 21, wherein said internal combustion engine is a two-stroke engine having an accumulator and a sump, each of said accumulator and said sump having a volume greater than that required for filling said combustion chamber, so that when the combustion mixture passes to said combustion chamber, there is no substantial limitation on the combustion mixture available for passing into said combustion chamber and therebeyond.

27. The internal combustion engine according to claim 26, further comprising a boost port from said accumulator to said combustion chamber and said sump, so that the combustion mixture is passable from both said sump and said boost port to said combustion chamber.

28. The internal combustion engine according to claim 21, wherein said internal combustion engine is a four-stroke engine having an inlet valve for an inlet, and an inlet manifold with a volume greater than that required for filling said combustion chamber, so that when the combustion mixture passes to said combustion chamber, there is substantially no limitation on the combustion mixture available for passing into said combustion chamber and therebeyond, and wherein said inlet manifold is dimensioned so that when a pulse is form in said inlet manifold by a rapid closure of said inlet valve, said pulse is propagated so that said pulse, or a harmonic thereof, returns to said inlet value when said inlet valve opens for a subsequent inlet stroke.

29. The internal combustion engine according to claim 28, wherein said pulse returned as the combustion mixture enters said combustion chamber ensures that the volume of the combustion mixture passing into said combustion chamber is greater than would occur had said pulse not so returned.

30. The internal combustion engine according to claim 16, wherein said internal combustion engine is a ramjet engine with combustion gasses having a pulse arrangement, so that a portion of said combustion gasses return towards an area of ignition for acting to retain the combustion mixture at an area of combustion for ensuring full combustion thereof.
